(19) United States
(12) Patent Application Publication
(10) Pub. No.: US 2022/0295820 A1
(43) Pub. Date: Sep. 22, 2022

(54) DEPOSITING METHOD AND DEPOSITOR PLATE

(71) Applicant: SOCIETE DES PRODUITS NESTLE S.A., VEVEY (CH)

(72) Inventors: JUAN ESTEBANEZ VILLACORTA, Santander (ES); CELINE CURIA, Santander (ES); BORISLAV ZDRAVKOV BORISOV, York (GB)

(21) Appl. No.: 17/636,504

(22) PCT Filed: Aug. 21, 2020
(86) PCT No.: PCT/EP2020/073506

§ 371 Date: Feb. 18, 2022

(30) Foreign Application Priority Data
Aug. 29, 2019 (EP) 19194283.8

(51) Int. Cl. A23G 3/34; A23G 3/20; A23G 3/02; A23G 1/00; A23G 1/20; A23G 1/21

(52) U.S. Cl. CPC A23G 3/0072; A23G 3/203; A23G 3/0029; A23G 3/0263; A23G 1/0066; A23G 1/0076; A23G 1/206; A23G 1/21

(57) ABSTRACT

A method and apparatus for producing confectionery products, preferably shells for chocolate products. The invention comprises depositing one or more inclusions into a mould cavity and depositing a food product into the mould cavity through a depositor plate comprising a plurality of nozzles.

### TECHNICAL FIELD

The invention relates particularly, but not exclusively, to methods and apparatus for producing confectionery products containing externally visible inclusions.

### BACKGROUND

Confectionery products are commonly produced with filled centres and an external shell, for example made from chocolate.

One existing method for producing such confectionery products with filled centres uses cold forming methods. In cold forming methods, a chocolate shell is first produced in a mould before the internal filling is added into the shell. Chocolate is added to a mould and a cold stamp is inserted into the chocolate to squeeze the chocolate around the stamp, forming the shell. After the filling has been added into the shell, the product is ‘backed-off’ (i.e. a layer of chocolate is deposited on the top of the shell and filling) with chocolate to seal the filling within the shell.

An alternative existing method for producing confectionery products with filled centres is so-called ‘single-shot’ depositing. In this technique, chocolate and filling are deposited into a mould simultaneously.

Confectionery products are sometimes provided with inclusions such as nuts or fruit or seeds in order to enhance the flavour and aesthetics of the product. These inclusions are traditionally covered or surrounded in a layer of chocolate and thus are not always visible externally.

These processes allow for elaborate and aesthetic confectionery to be conveniently produced.

However, the present inventors have identified an improved process that provides a reliable and efficient process for producing shells for confectionery products having inclusions that are more readily externally visible. Thus, thereby, improving aesthetics and also reducing the quantity of ingredients required to produce the visual effect of the confectionery product. By using this process the inclusions are locked within the chocolate shell hence no or very limited presence of loose pieces on the surface.

### SUMMARY OF THE INVENTION

Aspects of the invention are set out in the accompanying claims.

In a first aspect of the invention there is provided a method of producing a confectionery product containing externally visible inclusions, the method comprising: depositing one or more inclusions into a mould cavity; and depositing a food product into the mould cavity through a depositor plate, the depositor plate comprising a plurality of nozzles configured to direct at least a portion of the food product towards a wall of the mould cavity.

Thus, according to the invention a method for producing a confectionery product with externally visible inclusions is provided. As an example, the inclusions may be nuts, fruit, chocolate, and/or biscuit, or any other suitable inclusion, and the food product may be chocolate or any other suitable food product.

In a preferred embodiment, the invention provides a method of producing a shell for a confectionery product, a tablet of a confectionery product (e.g. a bar of chocolate) or a confectionery product piece (e.g. a bon bon). Each of the above may be filled with a filling or not filled. Although the preferred examples below are described in reference to a confectionery shell, the embodiment may be applicable to producing a tablet or a confectionery piece, where appropriate.

In a preferred embodiment, the confectionery product may comprise at least one wafer sheet within the shell. The shell may also comprise a filling and at least on wafer sheet. The wafer sheets may be incorporated individually or as a composite layered structure with fillings.

Furthermore, as an example, the chocolate material may be a dark chocolate, a milk chocolate or a white chocolate. The chocolate shell material comprises at least one fat. The fat may be cocoa butter, butterfat, a cocoa butter equivalent (CBE), a cocoa butter substitute (CBS), a vegetable fat that is liquid at standard ambient temperature and pressure (SATP, 25° C. and 100 kPa) or any combination of the above. In a particular embodiment, the chocolate shell material comprises cocoa butter.

By depositing the food product through a depositor plate comprising a plurality of nozzles, which are configured to direct at least a portion of the food product towards a wall of the mould cavity, the present method advantageously ensures that the deposited food product is spread or directed throughout the mould cavity.

Preferably, the food product is in liquid form when deposited. This may be achieved by heating the food product, preferably liquid chocolate or liquid compound. The term “liquid” means what is standard in the art, i.e. flowable under a force (e.g. gravity or applied). The temperatures and times for providing liquid and depositing chocolate are known in the art, for example, between 28 and 32 deg. C. In a preferred embodiment, the heated chocolate or compound has a viscosity between 1000 and 15000 mPas, preferably between 5000 and 10000 mPas.

In an embodiment, the food product is tempered to a liquid form, for example, the mass is heated to a temperature of between 40 and 45 deg C. and then cooled down to between 28 and 32 deg. C.

A wall of a mould activity is generally a non-central side portion of the mould cavity. For example, in a mould cavity for a rectangular (or near-rectangular) cross-section confectionery product, a wall of the mould cavity is the substantially vertical side portion of the mould cavity. Similarly, for a semi-circular (or near semi-circular) cross-section confectionery product, a wall of the mould cavity is a non-central side portion of the mould cavity.

Directing a portion of the food product towards a wall of the mould cavity can take multiple different forms. For example, the food product may be directed through nozzles that are perpendicular to a surface of the depositor plate to deposit the food product in a vertically downwards direction. Due to an angle of the wall of the mould cavity, the food product can be towards the wall of the mould cavity using this arrangement.

As an alternative example, the axes of the nozzles may be angled with respect to a surface of the depositor plate. Accordingly, the food product may be directed towards the wall of the mould cavity in this alternative arrangement.

Furthermore, in addition to directing a portion of the food product towards a wall of the mould cavity, the depositor plate may additionally direct a portion of the food product towards a central portion of the mould cavity.

Distributing the food product to a wall of the mould cavity prevents the entirety of the food product from being deposited centrally in the mould, thereby engulfing the inclusions in the food product. This helps to ensure that the inclusions are externally visible in the final confectionery product, thus improving aesthetics to the consumer and leading to a more appealing product.

Furthermore, the use of the depositor plate prevents the inclusions from being displaced within the mould cavity, or being ejected from the mould cavity, when the food product is deposited into the mould cavity. This ensures that the inclusions (which may for example be a high cost premium ingredient such as fruits or nuts) are located on the periphery of the product where they can be seen and not contained within the product where they are not required.

Advantageously, the plurality of nozzles may comprise: a first nozzle group configured to direct a first volume of the food product towards a central portion of the mould cavity; and a second nozzle group configured to direct a second volume of the food product towards the wall of the mould cavity. The arrangement of nozzles in this manner ensures the food product is deposited throughout the mould cavity.

In an embodiment, the total nozzles cover the following percentages of the surface area of the opening of the mould cavity, preferably from 2.5% to 25%, preferably from 5% to 20% and preferably from 7.5% to 15%. In a preferred embodiment, the first nozzle group (inner) covers the following percentages of the surface area of the opening of the mould cavity, preferably from 1% to 10%, preferably from 2% to 8% and preferably from 3% to 5%. In a preferred embodiment, the second nozzle group (outer) covers the following percentages of the surface area of the opening of the mould cavity, preferably from 1.5% to 15%, preferably from 3% to 12% and preferably from 4.5% to 10%.

In an embodiment, the total nozzles cover the following percentages of the surface area of the depositing area for each individual product of the depositor plate (e.g. FIG. 3A, 301), preferably from 5% to 40%, preferably from 10% to 30% and preferably from 15% to 25%. In a preferred embodiment, the first nozzle group (inner) covers the following percentages of the surface area of the opening of the mould cavity, preferably from 2% to 15%, preferably from 3% to 12% and preferably from 5% to 10%. In a preferred embodiment, the second nozzle group (outer) covers the following percentages of the surface area of the opening of the mould cavity, preferably from 3% to 25%, preferably from 7% to 18% and preferably from 10% to 15%.

The above percentages allow a preferred control of the flow of the food product into the mould cavity so as not to displace the inclusions unduly but also allow the inclusions to be securely attached to the food product in the final product. This feature preferably works in conjunction with the nozzle arrangement below. Additionally, by having a smaller depositing area than mould cavity size, the amount of food product wasted is minimised.

The shape of the nozzle is not particularly limited but is preferably substantially circular, square, rectangular, triangular, hexagonal, pentagonal, octagonal, etc., but preferably circular.

While two nozzle groups are described herein, the skilled person would appreciate that any number of nozzle groups could be used in order to deposit the food product within the mould cavity as desired. This allows inclusions to be more precisely located within the confectionery product shell.

Furthermore, nozzles of the second nozzle group may be arranged in a circumferential arrangement with respect to the first nozzle group. Such an arrangement allows the food product to be directed to the wall of the mould cavity, for example, without the need for potentially complex manufacturing techniques that angle the nozzles in particular directions. That is, the axis of the nozzles in the first and second nozzle groups may be perpendicular to a surface of the depositor plate, while still directing the food product to a wall of the mould cavity.

In a preferred embodiment, the centres of the nozzles in the first and second groups that are closest to each other are separated by a distance across the radius of the depositing section (301) of between 30% and 70%, preferably between 40% and 60% and most preferably between 45% and 55%. For example, referring to FIG. 4A, along the line A, the distance between the centres of the nozzles 312 and 311 from left to right is between 30% and 70% of the radius of the depositing section 301. These ranges allow the deposition to be sufficiently towards the walls and also sufficiently in the centre to control the position and secureness of the inclusions.

As an example, the first nozzle group may comprise 4 nozzles, and the second nozzle groups may comprise 8 nozzles located around a periphery of the nozzles of the first nozzle group are located substantially centrally with respect to the second nozzle group. It is appreciated that the total number of nozzles and the number of nozzles per nozzle group can be readily modified to suit particular requirements.

For example, the first nozzle group may comprise between 1 and 10 nozzles, preferably between 2 and 8 nozzles, more preferably between 3 and 6 nozzles. Furthermore, the second nozzle group may comprise between 4 and 20 nozzles, preferably between 6 and 16 nozzles, more preferably between 8 and 12 nozzles.

Advantageously, nozzles in the second nozzle group may be angled with respect to the axis of nozzles in the first nozzle group. Angling the nozzle groups in this manner helps to avoid displacing the inclusions within the mould cavity by affording greater control over placement of the food product.

The axis of a nozzle is the axis of the nozzle in the direction along which the food product flows through the nozzle during deposition into the mould cavity. The axis of a nozzle may be straight or could, for example, be arcuate, allowing greater precision in the direction of flow of the food product during deposition.

In some embodiments, the depositor plate may comprise additional nozzle groups for depositing the food product into additional mould cavities. In effect, the food product can be deposited into an array of mould cavities that can be filled simultaneously by providing an array of nozzle groupings.

As an example, the depositor plate may comprise one or more recesses in the plate in which the nozzle groups are formed to collect the food product before it is ejected through the nozzles during deposition. Each recess generally corresponds to a single confectionery product. However, a single recess may correspond to multiple confectionery products. Multiple nozzle groups may be provided per recess to allow portions of the food product to be directed at different angles for a single confectionery product.

As such, a depositor plate may include an array of recesses, each having a plurality of nozzle groups formed therein, each recess corresponding to a particular mould cavity for a confectionery product in an array of mould cavities.

This allows multiple confectionery product shells to be produced simultaneously using a single depositor plate, thereby increasing production speed and efficiency.

In some embodiments, the method may include the additional step of inserting a stamp into the mould cavity to cool the food product and to preferably press the food product towards the wall of the mould cavity. In such as arrangement the stamp may be in the form of two portions: a first portion of the stamp (which may have a shape complimentary to a shape of the mould cavity) being configured to enter the mould during insertion of the stamp such that a distance between a central region of an outer surface of the second portion of the stamp and an inner surface of the mould cavity is greater than the greatest dimension of an inclusion; and a second portion of the stamp which does not enter the mould cavity during insertion of the stamp. For a generally spherical inclusion this may be, for example, a diameter of the one or more inclusions.

The use of a stamp in this manner is useful in moulding the food product to the shape of the mould cavity, without crushing (and causing damage to) or squashing the inclusions, whilst preferably additionally preventing the food product from overflowing the mould cavity (by fully inserting the stamp).

The complementary shape of the stamp is dependent upon the desired profile of the shell and the particular shape of the mould cavity used. For example, for a cross-section semi-circular mould cavity, i.e. when viewed from the side, not the profiled side or optional flat bottom, a semi-circular portion could be used, wherein the radius of the semi-circular portion of the stamp is smaller than the radius of the semi-circular mould cavity. This would produce a semi-circular shell of uniform thickness. Here there is room or space for the food product (and any inclusions) between the inner surface of the mould cavity and the outer surface of the semi-circular portion of the stamp.

In an embodiment, the mould cavity comprises a curved bottom surface. A skilled person understands that in particular the radius of the curved bottom section could be adapted to the specific inclusions used for manufacturing a respective confectionery product, thereby adjusting the space/angles between the curved bottom section and the inclusions. It is noted that the % of inclusions and/or (preferably and) the size of the inclusions specified below assist in ensuring the % visibility provided by the method of the present invention.

In an embodiment, the mould cavity may comprise a flat bottom surface. The advantage of the curved surface is maximising the visibility of the inclusions.

In an embodiment, e.g. as shown in FIG. 5 at point 403, the walls are angled from the vertical, preferably are inclined by at least 1°, more preferably by at least 5° or at least 10° with respect to a vertical line from the bottom side to the profiled side. The maximum inclination may preferably be less than 20° or less than 15°. Accordingly, to exemplify this embodiment, the upper profiled surface is circular when viewed above and the bottom surface is a larger circle as the walls slope away from the upper profiled surface.

The shape of the bottom surface, e.g. the surface prepared by backing off, is not limited. In the examples of the invention, this surface is circular but could a regular polyhedron.

However, it is not essential that the shell is required to have a uniform thickness. Accordingly, while the shape of the stamp may be exactly complementary to the shape of the mould cavity (allowing uniform shell thickness), the shape of the stamp may be only approximately complementary to allow the thickness of the shell to vary across different portions of the shell.

For example, a central region of the shell (which may be where the inclusions are located) may have a greater thickness than a side or peripheral portion of the shell.

While the distance between the central region of an outer surface of the second portion of the stamp and an inner surface of the mould cavity may be set to be greater than a diameter of the one or more inclusions, the distance could instead be set according to any other suitable dimension, or a volume, of the one or more inclusions that allows damage to the inclusions to be prevented.

As an example, the central region of the outer surface of the second portion of the stamp may be 3 to 6 mm (e.g. 4 mm) from the inner surface of the mould cavity when the stamp is fully inserted into the mould cavity, while a non-central (or side) region of the outer surface of the second portion of the stamp (corresponding to the wall of the mould cavity) may be less, for example, 2 mm from the inner surface of the mould cavity when the stamp is fully inserted into the mould cavity.

Advantageously, the second portion of the stamp may abut a rim of the mould cavity during insertion of the stamp to fully insert the stamp into the mould. Fully inserting the stamp (such that the second portion of the stamp abuts the rim of the mould cavity) allows for control of the shell thickness at a non-central (or side) portion of the shell, including near the rim of the mould cavity, as compared to, for example, only partially inserting the stamp into the mould cavity.

However, the stamp may alternatively only be partially inserted into the mould cavity such that the second portion of the stamp does not abut the rim of the mould cavity. This arrangement allows excess food product to leave the mould.

Advantageously, the stamp may additionally comprise a chamfer located between the first portion and the second portion. The chamfer increases the surface area of the shell close to the opening of the mould cavity. As a result, the surface area of a seal created during ‘backing-off’ of the confectionery product is increased, improving the quality of the seal. The chamfer may, for example, be angled at approximately 45 degrees with respect to the second surface, however a range of different angles are possible. The term ‘backing-off’ refers to the process of laying a layer of food product (for example chocolate) over the open end of the confectionery (or other) product to enclose the contents.

According to this embodiment, the temperature of the stamp may be selected to cause the food product to at least partially solidify when inserting the stamp into the mould cavity. This allows desired shell thicknesses to be reliably produced. The stamp can, for example, be cooled to a temperature of approximately −5° C. or to −15° C. or to −21° C., depending on the particular properties of the food product, however other temperatures are possible depending on the specific ingredients.

The stamp can be held in place within the mould cavity for approximately 2 seconds to 5 seconds to allow the food product to solidify, however other durations are possible again according to ingredients. The exact time required is dependent upon the particular properties of the food product.

According to some embodiments, depositing one or more inclusions into a mould cavity may comprise depositing through an inclusion depositor. The inclusion depositor may comprise: an upper plate comprising one or more holes; a lower plate comprising one or more holes, the intermediate plate positioned proximate to the mould cavity during deposition of the one or more inclusions; and an intermediate plate comprising one or more holes, the intermediate plate positioned between the upper plate and the lower plate.

Advantageously, here the intermediate plate may be slideable between a first position, in which the one or more holes of the intermediate plate are aligned with the one or more holes of the upper plate, and a second position, in which the one or more holes of the intermediate plate are aligned with the one or more holes of the lower plate. Thus, during deposition of the one or more inclusions into the mould cavity, the one or more inclusions sequentially pass through the upper plate, the intermediate plate and the lower plate.

The use of the inclusion depositor allows for the precise quantity control of inclusions within the mould cavity, as well as producing an even distribution of inclusions across the mould cavity, helping to keep the inclusions in the shell of the confectionery product where they can be seen. The number of holes in each of the plate of the inclusion depositor may correspond to the number of mould cavities to be filled.

To avoid damaging the inclusions during deposition, the one or more holes of the upper plate may include a chamfer. Furthermore, the upper plate may be provided with a rim to contain the inclusions before they are deposited into the one or more mould cavities.

An actuator may additionally be provided to actuate the intermediate plate during deposition, causing the intermediate plate to slide between a first and second position.

Furthermore, the one or more holes of the lower plate of the inclusion depositor may have a diameter that is greater than a diameter of the one or more holes of the upper plate of the inclusion depositor. The one or more holes of the intermediate plate may have a conical shape, and the one or more holes of the intermediate plate may have a smallest diameter equal to the diameter of the one or more holes of the upper plate. Finally, the one or more holes of the intermediate plate may have a largest diameter equal to the one or more holes of the lower plate.

This arrangement advantageously allows all inclusions added to the inclusion depositor to be deposited, avoiding inclusions becoming trapped inside the inclusion depositor. Furthermore, the inclusion depositor of this embodiment allows control over inclusion homogeneity in size, as well as distribution across mould cavities.

Advantageously, the one or more holes of the upper plate may be laterally offset from the one or more holes of the lower plate. This prevents accidental deposition of the inclusions, providing greater quantity control and inclusion placement.

In some embodiments, the method includes the additional step of vibrating the mould cavity after depositing the food product into the mould cavity. This helps to create a smooth and even shell and allows for greater control of the thickness of the shell. However, the intensity and duration of vibration that is used can be reduced as compared to a situation where the depositor plate of the present invention is not used to deposit the food product into the mould cavity.

In a further aspect of the invention there is provided a method for producing a confectionery product containing externally visible inclusions, the method comprising the method of producing a confectionery product as described herein, and further comprising the steps of: after removing the stamp form the mould cavity, depositing a second food product into a cavity of the shell of the confectionery product; depositing a third food product third onto the mould cavity using a second depositor plate to seal the second food product within the first and third food products.

Accordingly, a filled confectionery product containing externally visible inclusions can be produced reliably and efficiently. The use of a second depositor plate when depositing the third food product prevents the third food product from mixing with the second food product.

The second food product can be a filling, such as jelly, mousse, ganache, caramel, chocolate, honeycomb, or any other suitable filling, particularly any filling commonly used in the confectionery industry, preferably for filling chocolate shells. Furthermore, the second food product may consist of multiple different food products. The third food product can be the same as the food product forming the shell, or could be a different food product.

According to this aspect, the cross-sectional area over which the third food product is deposited through the second depositor may be smaller than a cross-sectional area of the mould cavity at the rim of the mould cavity. This helps to seal the confectionery product, while preventing spillage of the third food product outside of the mould cavity, causing wastage of (potentially expensive) ingredients.

As an example, the confectionery product may have a circular cross-sectional shape, with a diameter of between 25 mm and 35 mm (for example 31 mm,) while the second depositor plate only deposits the third food product over 20 to 24 mm (for example 22.34 mm). Similar proportions may also be present in the first food product deposition plate.

According to a further aspect of the invention, there is provided an inclusion depositor for depositing inclusions into mould cavities, the inclusion depositor comprising: an upper plate comprising one or more holes; a lower plate comprising one or more, the intermediate plate positioned proximate to the mould cavity during deposition of the one or more inclusions; and an intermediate plate comprising one or more holes, the intermediate plate positioned between the upper plate and the lower plate; wherein the intermediate plate is slideable between a first position, in which the one or more holes of the intermediate plate are aligned with the one or more holes of the upper plate, and a second position, in which the one or more holes of the intermediate plate are aligned with the one or more holes of the lower plate.

The inclusion depositor allows for the precise quantity control of inclusions within the mould cavity, as well as producing an even distribution of inclusions across the mould cavity, helping to keep the inclusions in the shell of the confectionery product where they can be seen. The number of holes in each of the plates of the inclusion depositor may correspond to the number of mould cavities to be filled.

To avoid damaging the inclusions during deposition, the one or more holes of the upper plate may include a chamfer. Furthermore, the upper plate may be provided with a rim to contain the inclusions before they are deposited into the one or more mould cavities.

An actuator may additionally be provided to actuate the intermediate plate during deposition, causing the intermediate plate to slide between a first and second position.

According to a further aspect of the invention there is provided a depositor plate for use in producing shells for confectionery products containing externally visible inclusions, the depositor plate comprising: a first nozzle group configured to direct a first volume of a food product towards a central portion of a mould cavity; a second nozzle group configured to direct a second volume of the food product towards a wall of the mould cavity, wherein nozzles in the second nozzle group are angled with respect to the axis of nozzles in the first nozzle group, wherein the axis of nozzles in the first nozzle group is generally perpendicular to a surface of the depositor plate, and nozzles of the second nozzle group are arranged in a circumferential arrangement with respect to the first nozzle group. The arrangement may further comprise additional nozzle groups for depositing the food product into additional mould cavities.

Thus, according to this aspect, a depositor plate is provided which allows a food product to be deposited towards a wall of a mould cavity, ensuring that the deposited food product is spread throughout the mould cavity. This prevents the entirety of the food product from being deposited centrally in the mould, thereby engulfing the inclusions in the food product, and reduces the need to vibrate the mould to create a uniform shell thickness. Furthermore, the depositor plate prevents the inclusions from being flooded and covered by the food product when the food product is deposited into the mould cavity.

According to a further aspect of the invention there is provided a stamp for use in producing a confectionery product, the stamp comprising: a first portion configured to penetrate the mould cavity, wherein the first portion of the stamp has a shape complementary to a shape of the mould cavity, and wherein the first portion is shaped such that, when the first is inserted into the mould cavity, a distance between an outer surface of the second portion of the stamp and an inner surface of the mould cavity is greater than a diameter of the one or more inclusions; and second portion configured to not penetrate the mould cavity.

Thus, according to this aspect, a stamp is provided which can be fully inserted into a mould cavity, thus reducing the quantity of food product that is ejected from the food cavity, while avoiding crushing of squashing of the inclusions.

According to a further aspect of the invention there is provided an apparatus for producing a confectionery product containing externally visible inclusions, the apparatus comprising: the inclusion depositor plate as described herein; the depositor plate as described herein; and the stamp as described herein.

The various components of the apparatus each work together with one another to aid the production of a confectionery product with externally visible inclusions, as described above. While the use of any one component is not essential, their use helps to improve the quality of the finished product and/or shell.

Furthermore, additional components may be included in the apparatus. For example, the apparatus may further include a second depositor plate for depositing the third food product as described herein.

According to a further aspect of the invention there is provided a confectionery product comprising a shell produced according to a method as described herein.

According to yet another aspect of the invention there is provided a confectionery product produced according to a method described herein.

According to any of the above aspects of the invention, the food product comprises chocolate; and the inclusions comprise one or more of nuts, fruit, seeds, chocolate, and biscuit, or any combination thereof. The use of other suitable food products and inclusions is, however, possible.

### BRIEF DESCRIPTION OF THE DRAWINGS

Embodiments of the invention will now be described, by way of example only, with reference to the following figures.

In accordance with one (or more) embodiments of the present invention, the Figures show the following:

FIGS. 1A-C show a traditional method for producing chocolate shells for confectionery products;

FIG. 2A shows a cross-sectional view of an inclusion depositor with an intermediate in a first position according to an example of the disclosure;

FIG. 2B shows a cross-sectional view of an inclusion depositor with an intermediate in a second position according to an example of the disclosure;

FIG. 3A shows a depositor plate for depositing a food product into a mould cavity;

FIG. 3B shows the depositor plate shown in FIG. 3A from an alternative angle;

FIG. 4A shows a close-up view of the depositor plate shown in FIGS. 3A and 3B;

FIG. 4B shows a cross-sectional view of the depositor plate shown in FIG. 4A;

FIG. 5 shows a depositor plate and mould cavity for deposition of a food product;

FIG. 6A shows a stamp and mould cavity for shaping deposited chocolate;

FIG. 6B shows the stamp of FIG. 6B when inserted into the mould cavity;

FIG. 6C shows a shell for a confectionery product in a mould cavity after the stamp has been removed from the mould cavity;

FIG. 7 shows a flow diagram of the steps of a method for producing shells for confectionery products;

FIG. 8 shows a flow diagram for producing filled confectionery products, continuing from the flow diagram shown in FIG. 7;

FIGS. 9A-9D show inventive example confectionery products produced according to example techniques described herein;

FIGS. 10A and 10B show a depositor plate for backing off a confectionery product.

FIGS. 11A and 11B show a side-by-side comparison of comparative examples using a ‘single-shot’ deposition technique and the inventive examples of the present application.

Any reference to prior art documents in this specification is not to be considered an admission that such prior art is widely known or forms part of the common general knowledge in the field.

As used in this specification, the words “comprises”, “comprising”, and similar words, are not to be interpreted in an exclusive or exhaustive sense. In other words, they are intended to mean “including, but not limited to”.

### DETAILED DESCRIPTION

As discussed above, the present invention relates to providing a food product, preferably a confectionery product, preferably a chocolate-product, comprising visible inclusions.

In a preferred embodiment, the invention provides a method of producing a shell for a confectionery product, a tablet of a confectionery product (e.g. a bar of chocolate) or a confectionery product piece (e.g. a bon bon). Each of the above may be filled with a filling or not filled. Although the preferred examples below are described in reference to a confectionery shell, the embodiment may be applicable to producing a tablet or a confectionery piece, where appropriate. However, the most preferred embodiment of the present invention relates to preparing a shell for a confectionery product.

As used herein the term ‘inclusion’ denotes an edible body and/or particle of distinct composition which is embedded (or capable of being embedded) wholly or partially in a food composition. Inclusions are often used to provide contrasting texture, hardness, visual appearance and/or flavour to the material in which they are embedded thus a unique eating and sensory experience to the consumer consuming the product. Typically, more than one inclusion will be incorporated in single portion of the food composition that comprises inclusions. It can be desirable in many products for inclusions to be dispersed as evenly as possible within the product (or within a sub-set of the product such as in a layer or filling thereof) so each mouthful of the product provides a consistent eating experience.

Conveniently, the inclusions comprise any of the following non-limiting list (more conveniently selected from the group consisting of):
fruits or fruit pieces which may comprise: hard fruits (e.g. seeds, nuts such as hazelnuts, almonds, brazil nuts, cashew nuts, peanuts, pecans and/or similar); soft fruits (e.g. raisins, cranberries, blueberries, blackcurrant, apples, pear, orange, apricot and/or similar); and/or freeze-dried fruit pieces, candied fruit and/or alcohol-soaked fruit, preferred soft fruits are dried fruits;
crispy inclusions (e.g. caramel, coffee, biscuits, wafer, etc.);
herbs (for example chives, dill, coriander, parsley);
cereals (for example puffed rice, puffed wheat, extruded cereal pieces);
chocolate or choco-material (for example chocolate vermicelli, chocolate shapes);
sugar confectionery (for example cinder toffee pieces, toffee, fudge, caramel, fondant pieces, jelly pieces;
marshmallow, sugar-panned centres such as those available commercially from Nestle under the trade mark mini SMARTIES®); and/or
any suitable mixtures and/or combinations thereof.

Preferred inclusions have an average size from 1 to 50 mm, from 2 to 40 mm, from 3 to 25 mm or from 5 to 10 mm or from 2 to 6 mm.

In a further example, the product produced according to the method and apparatus described herein comprises inclusions with an average diameter greater than 2 mm, for example inclusions, which are retained by a sieve with a 2 mm opening. The inclusions may have a diameter ranging from 2 mm to 22.6 mm, for example inclusions, which pass through a sieve with an opening of 22.6 mm but are retained by a sieve with a 2 mm opening. The inclusions may have a diameter ranging from 2.83 mm to 11.2 mm, for example inclusions, which pass through a sieve with an opening of 11.2 mm but are retained by a sieve with a 2.83 mm opening.

As mentioned above, the term “visible inclusions”, e.g. fruits, nuts, dried fruit etc., means that the preferably particulate inclusions are visible at an external surface of the product, i.e. that at least a portion of the fruits or fruit pieces facing to an external surface of the chocolate product is not covered with material, preferably chocolate material, but is visible for a consumer. The inclusions are preferably visible on the profiled side of the chocolate product which is opposed to the flat bottom side.

Within the context of the present invention, the term “profiled side” of the product indicates the side, aspect or surface which is opposed to the bottom side and which is shaped by moulding in the moulds according to the present invention. For the sake of clarity, the profiled side of the product corresponds to that side, aspect or surface of the product which, during the moulding process, is in contact with the mould surface.

Preferably, the product comprises between 25 and 100% surface area coverage, for example, between 30 and 95%, between 40 and 90%, or between 50% and 80% visible inclusions with respect to the profiled side surface of the product.

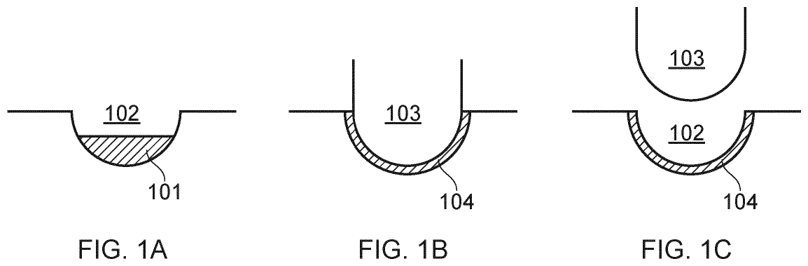

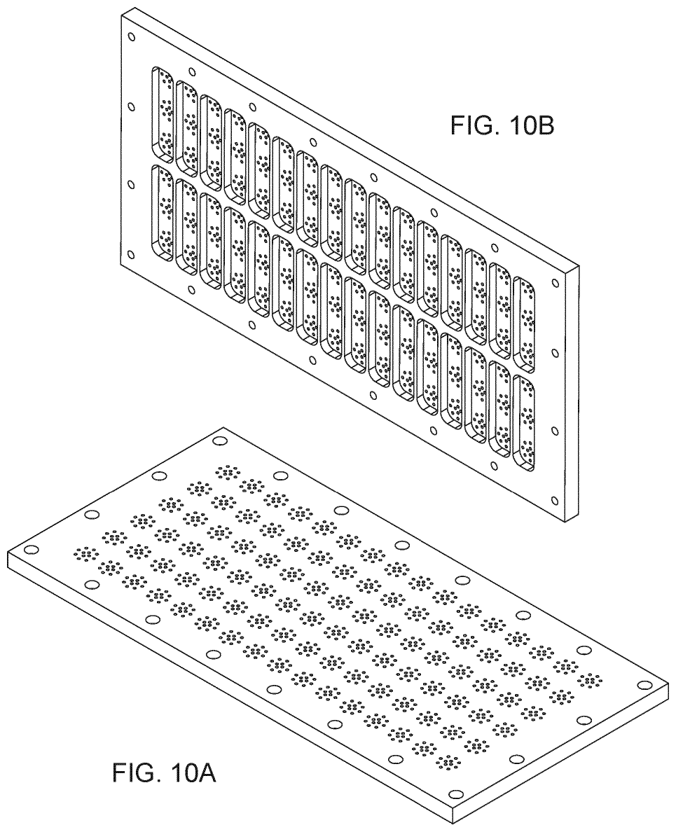

FIGS. 1A to 10 illustrate an example of a traditional method for producing chocolate shells for confectionery products. First, as shown in FIG. 1A, chocolate 101 is deposited into a mould cavity 102. After the chocolate 101 has been deposited, a stamp 103 is inserted into the mould cavity 102 to shape the chocolate into a shell 104, as shown in FIG. 1B. Then, as demonstrated in FIG. 10, the stamp 103 is removed, after which the chocolate shell 104 may be filled with a filling before the product is ‘backed-off’ by depositing a thin layer of chocolate on top of the filling to seal the filling within the chocolate to produce a filled confectionery product. The finished product can then be removed from the mould cavity 102 for packing and subsequent distribution.

Such a method is commonly referred to as ‘cold-forming’ or ‘cold-stamping’. These operations can be carried out on large single or multiple rows of mould cavities simultaneously to facilitate mass production of confectionery products.

These traditional methods are, however, unsuitable for producing shells for confectionery products containing inclusions that are visible externally (i.e. not entirely covered in a layer of chocolate). Whilst it is accepted that it is known in the art to use such methods to produce chocolate shells where inclusions are contained within the shell, the prior art methods do not offer the requisite control of the process steps in order to produce a product with visible inclusions that are securely attached to the shell and in a manner that is industrially feasible.

According to an example teaching of the disclosure, in order to produce such shells inclusions are initially deposited in a mould cavity.

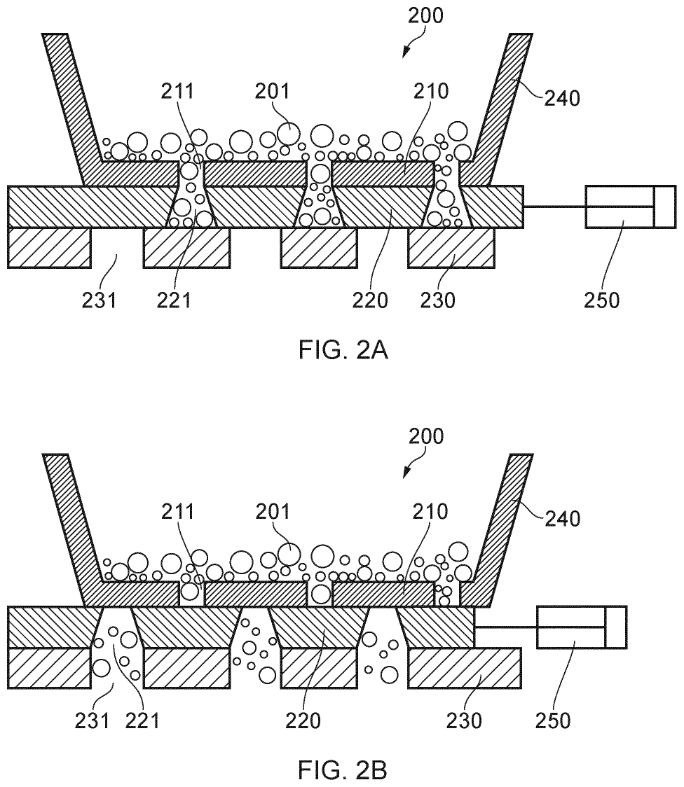

FIG. 2A illustrates a cross-sectional view of an inclusion depositor 200, which may be used for depositing inclusions 201 into a mould according to an example teaching of the disclosure. The depositor includes an upper plate 210, which includes one or more holes 211 through which the inclusions 201 can pass, and a lower plate 230, which includes one or more holes 231 through which the inclusions can pass. The depositor also includes an intermediate plate 220 disposed between the upper plate 210 and the lower plate 230, the intermediate plate 220 comprising one or more holes 221.

As shown, the holes of the upper plate 210 and lower plate 230 may not be aligned with each other (i.e. may be laterally offset) such that inclusions 201 cannot fall directly through both sets of holes.

In the present example, each of the holes in the upper plate 210, intermediate plate 220 and lower plate 230 correspond to a particular mould cavity for a confectionery product. However, each of the upper plate 210, intermediate plate 220 and lower plate 230 could include multiple holes per mould cavity.

In this example, the diameter of the holes 211 of the upper plate 210 is smaller than the diameter of the holes 231 of the lower plate 230. As shown, the holes 221 of the intermediate plate 220 may be conical with an upper diameter (proximate to the upper plate 210) equal to the diameter of the holes 211 of the upper plate 210 and a lower diameter (proximate to the lower plate 230) equal to the diameter of the holes 231 of the lower plate 230. Although not shown, chamfers (or an edge radius) may be provided on any of the holes of the upper plate 210, intermediate plate 220 and/or lower plate 230 to avoid cutting or otherwise damaging the inclusions 201 during deposition.

The intermediate plate 220 is slideable between a first position and a second position during the deposition process using an actuator 250. FIG. 2A illustrates the depositor 200 with the intermediate plate 220 in the first position. In the first position, the holes 221 of the intermediate plate 220 are aligned to the holes 211 of the upper plate 210 to allow the inclusions 201 to fall through the holes 211 of the upper plate 210 and into the holes 221 of the intermediate plate 220.

FIG. 2B illustrates the depositor 200 with the intermediate plate 220 in the second position. In this position, the holes 221 of the intermediate plate 220 are aligned to the holes 231 of the lower plate 230 to allow the inclusion to fall from the holes 221 of the intermediate plate 220, through the holes 231 of the lower plate 230, and into mould cavities.

During deposition of the inclusions 201, the intermediate plate 220 is initially in the first position. The inclusions 201 are placed on a top surface of the upper plate 210 and are contained by a rim 240 of the upper plate 210. Due to the alignment of the holes of the upper plate 210 and the intermediate plate 220, some or all of the inclusions 201 fall into the holes 221 of the intermediate plate 220.

The actuator 250 then slides the intermediate plate 220 into the second position. The inclusions 201 previously positioned in the holes 221 of the intermediate plate 220 are able to pass through the holes 231 of the lower plate 230 and fall into a mould cavity.

The actuator 250 may cause the intermediate plate 220 to move between the first and second position many times during deposition, potentially many times per second.

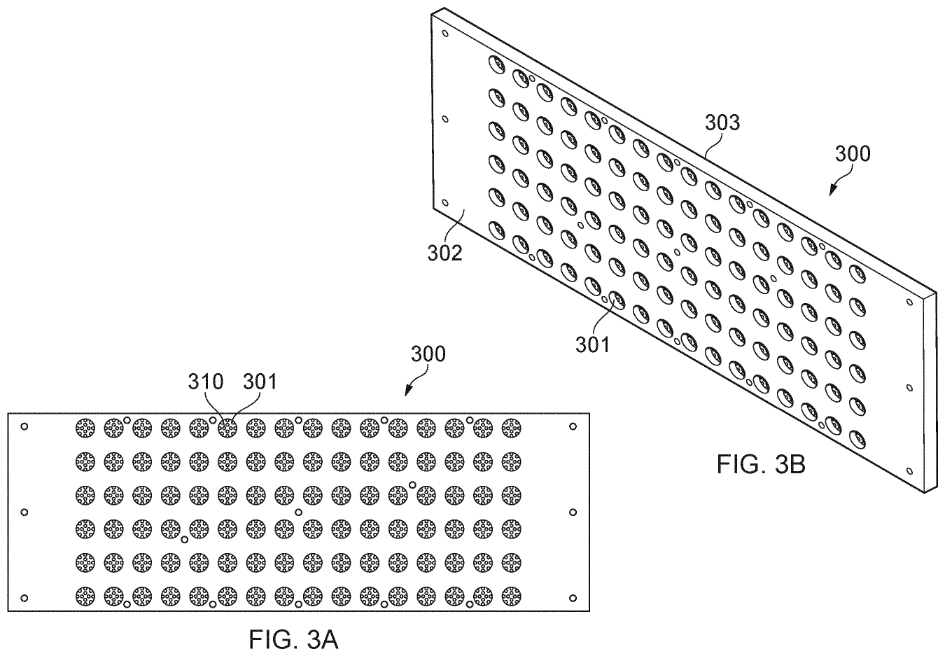

After the inclusions 201 have been deposited in mould cavities, chocolate is deposited in the mould cavities for producing the shells for the confectionery products. The chocolate may be deposited through a depositor plate such as that shown in FIGS. 3A and 3B.

FIG. 3A illustrates a depositor plate 300 for depositing chocolate (or any suitable food product) into multiple mould cavities. The depositor plate 300 may include a plurality of depositing sections 301, each depositing section including a plurality of nozzles 310. The depositor plate shown contains 96 depositing sections 301 and is therefore capable of depositing chocolate into up to 96 separate mould cavities. However, multiple depositing sections 301 could be used to deposit chocolate into a single mould cavity. Further, different numbers of depositing sections 301 are possible.

As shown in FIG. 3B, the depositor plate 300 includes a top surface 302 and a bottom surface 303 (no shown). The bottom surface is the surface positioned closest to the mould cavities during deposition. Furthermore, the depositing sections 301 may be recessed in the top surface 302 of the depositor plate 300, as shown.

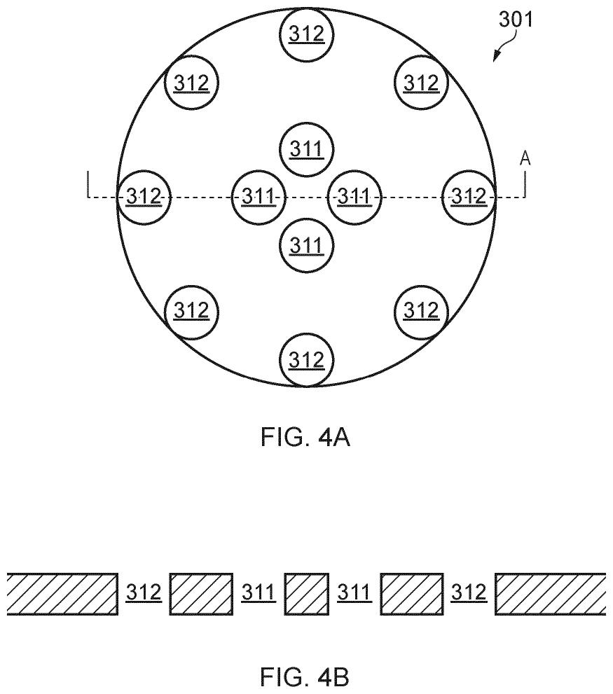

FIG. 4A provides a close up view of a depositing section 301. The depositing section 310 shown is circular in shape, however the shape of the depositing sections 310 is dependent upon the shape of the mould cavities into which chocolate is deposited and may, therefore, be different.

The depositing section 301 includes a plurality of nozzles, in particular, the depositing section may include a first nozzle group 311 and a second nozzle group 312. The nozzles in the first nozzle group 311 are positioned in a central region of the depositing section 301. During deposition, the nozzles in the first nozzle group 311 are located directly above a central region of a mould cavity so as to deposit chocolate towards the central region of the mould cavity.

In the example of FIG. 3A, the first nozzle group 311 contains 4 nozzles and the first nozzle group 312 contains 8 nozzles, however different nozzle numbers and arrangements are possible.

The nozzles in the second nozzle group 312 are located at a periphery of the depositing section 301. As shown in FIG. 4A, the nozzles in the second nozzle group 312 may be located in a circumferential arrangement with respect to the nozzles in the first nozzle group 311.

During deposition, the nozzles in the second nozzle group 312 may be located directly above a wall of a mould cavity so as to deposit chocolate towards the wall of the mould cavity. Alternatively, the nozzles in the second nozzle group 312 may be angled with respect to the nozzles of the first nozzle group and accordingly the nozzles are not required to be located directly above the wall of the mould cavity during deposition.

FIG. 4B illustrates a cross-section the depositing section 301 of depositor plate 300 taken along line A-A shown in FIG. 4A. As shown, the axis of the nozzles in both the first nozzle group 311 and second nozzle group 312 (that is the axis of the nozzles in the direction along which the food product flows through the nozzle during deposition into the mould cavity) are perpendicular to the bottom surface 303 of the depositor plate 300.

However, the axis of one or more nozzles in either of the nozzle groups could be formed with a different angle with respect to the bottom surface 303 of the depositor plate 300. In particular, nozzles in the second nozzle group 312 may be angled with respect to the nozzles of the first nozzle group, allowing the food product to be deposited in different directions.

For example, the nozzles of the second nozzle group 312 may be angled radially outwards with respect to the perpendicular axis of the nozzles of the first nozzle group 311. The angle with respect to the perpendicular axis of the nozzles of the first nozzle group 311 could be 4-5 degrees, however other angles are possible.

Furthermore, while the axes of the nozzles are depicted as being straight, they could, for example, instead be arcuate, allowing greater precision in direction the flow of the food product during deposition.

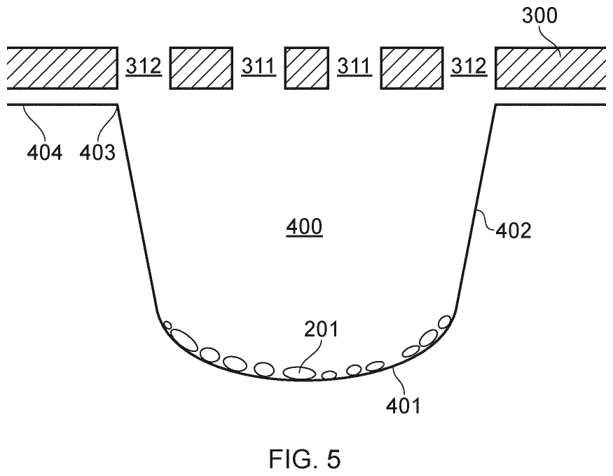

FIG. 5 illustrates the positioning of the depositor plate 300 with respect to a mould cavity 400. The mould cavity 400 includes a central portion 401 in which inclusions 201 are generally located. The mould cavity 400 also includes a wall 402. The wall 402 of the mould cavity 400 is shown as being near-vertical in order to allow chocolate to be deposited onto the wall 402 through the depositor plate 300. However the gradient of the wall 402 could be much shallower than that shown and could be curved. The mould cavity 400 is formed out of a top surface 404 of a plate and the mould cavity 400 includes a rim 403 where the wall 402 meets the top surface 404.

During deposition, chocolate passes through the nozzles in the first nozzle group 311 of depositor plate 300 to deposit chocolate towards the central portion 401 of the mould cavity.

Furthermore, chocolate passes through the nozzles in the second nozzle group 312 of the depositor plate 300 to deposit chocolate towards the wall 402 of the mould cavity 400.

After the chocolate 101 has been deposited into the mould cavity 400, a modified stamping or ‘cold-forming’ process or is used to shape the deposited chocolate 101.

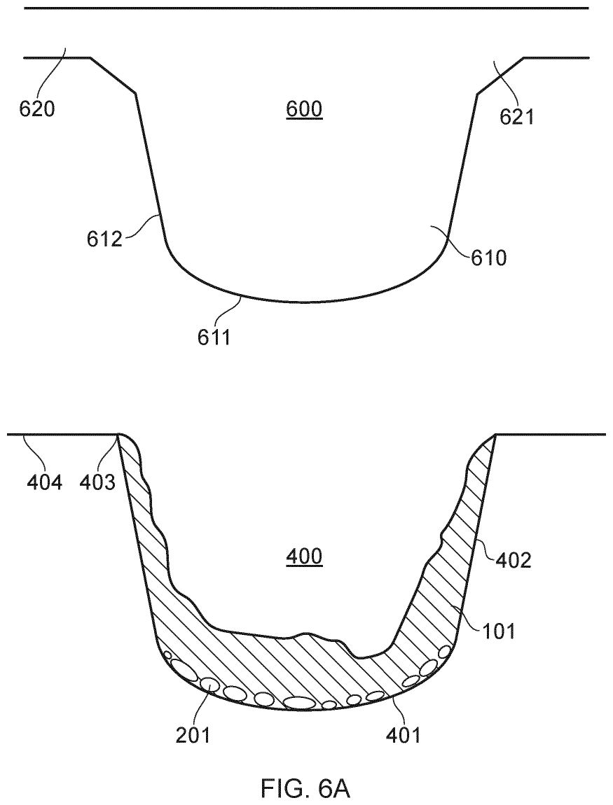

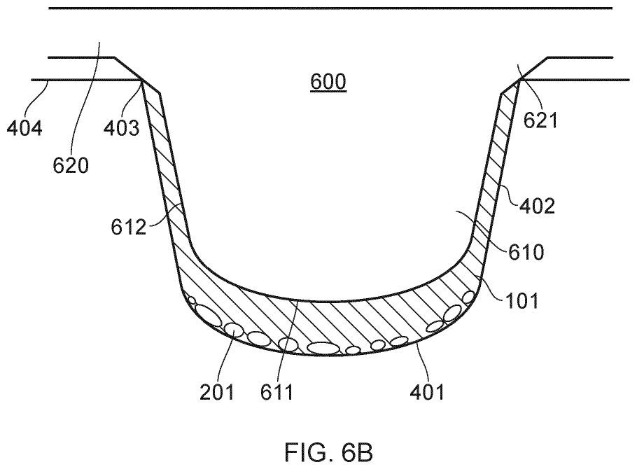

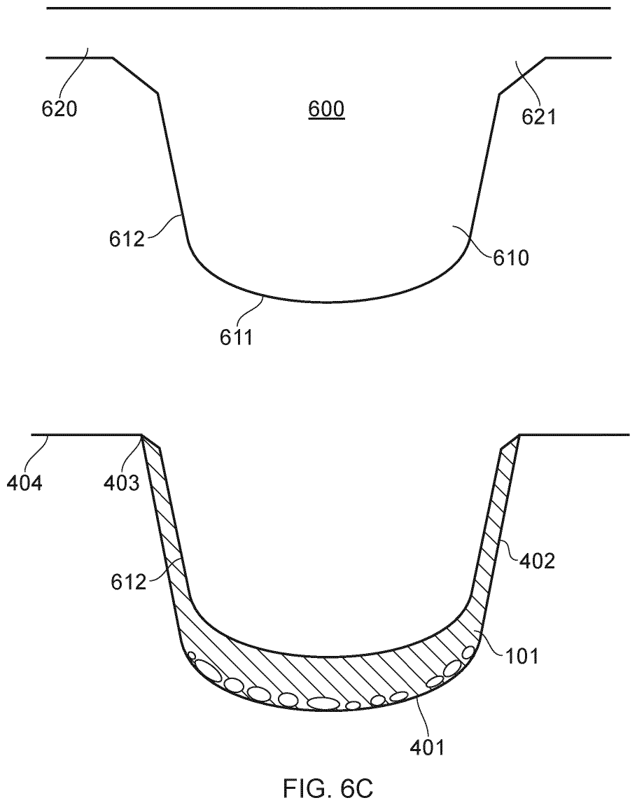

FIG. 6A illustrates a stamp 600 used in the modified stamping process. The stamp 600 includes a first portion 610 and a second portion 620, with the first portion 610 protruding from the second portion 620. The first portion 610 of the stamp is configured to penetrate the mould cavity 400 during the stamping process. The first portion 610 of the stamp 600 includes a central surface 611 corresponding to the central portion 401 of the mould cavity 400, and a side surface 612 corresponding to the wall 402 of the mould cavity 400.

In FIG. 6A, the chocolate 101 prior the stamping process is shown as extending along an entire height of the wall 402 of the mould cavity 400 to the rim 403. However, it is appreciated that the chocolate 101 is not required to extend along the entire height of the wall 402 but may instead extend only partially along the wall 402, for example 50% (or less) of the height of the wall 402.

The second portion 620 includes a surface that is generally parallel to the top surface 404 out of which the mould cavity 400 is formed during the stamping process.

The stamp 400 may also include a chamfer or edge radius 621 located between the first portion 610 and the second portion 620, however the chamfer 621 may be considered to form part of the second portion 620.

As shown in FIG. 6B, during the stamping process the stamp 600 is lowered toward the mould cavity 400 such that the first portion 610 penetrates the mould cavity 400. The stamp 600 is lowered until the second portion 620 or the chamfer 621 abuts the top surface 404 or rim 403, thereby fully inserting the stamp 600 into the mould cavity.

As shown, a distance between the central surface 611 of the first portion 610 and the central portion 401 of the mould cavity 400 is larger than the diameter of the inclusions 201, such that the inclusions 201 are not damaged when the stamp 600 is fully inserted into the mould cavity 400. Moreover, the inclusions do not pierce through the chocolate shell, which would cause a filling of a finished confectionery product to leak. Furthermore, the distance between the central surface 611 of the first portion 610 and the central portion 401 of the mould cavity 400 is larger than a distance between the side surface 612 of the first portion 610 and a wall 402 of the mould cavity 400.

The insertion of the first portion 610 of the stamp 600 into the mould cavity 400 helps to shape the chocolate 101 into a shell shape with controlled thickness.

Furthermore, at least the first portion 610 of the stamp 600 may be cooled to cause the chocolate 101 in the mould cavity 400 to at least partially solidify when in contact with the stamp 600.

As shown in FIG. 6C, the stamp 600 is then removed from the mould cavity 400 leaving an empty shell for a confectionery product in the mould cavity. The empty shell can then be filled with a suitable filling (such as jelly, chocolate, mousse, honeycomb, etc.) and a chocolate base deposited on top of the mould cavity to seal (back-off) the filling within the chocolate.

As shown, the portion of the shell proximate the rim 403 of the mould cavity may have an angled surface relative to the top surface 404 created by the chamfer 621 of the stamp 600. During any subsequent backing-off of the shell, the angled surface of the shell proximate the rim 403 provides a large surface area for improving the quality of the seal between the shell and the back-off.

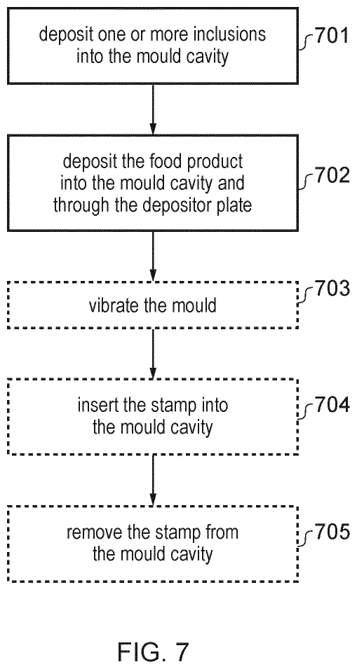

FIG. 7 is a flow chart for producing shells for confectionery products containing externally visible inclusions. At step 701 inclusions 201 are deposited into a mould cavity 400. The inclusions may be deposited using the inclusions depositor shown in FIGS. 2A and 2B, however the inclusions could be deposited using alternative deposition means known in the art.

At step 702, the food product (for example chocolate) is deposited into the mould cavity 400 through a depositor plate, the depositor plate comprising a plurality of nozzles configured to direct at least a portion of the food product towards a wall of the mould cavity. The depositor plate may be the depositor plate 300 depicted in FIGS. 3A, 3B 4A and 4b, however other depositor plates including a plurality of nozzles configured to direct at least a portion of the food product towards a wall 402 of the mould cavity 400 could be used.

Optionally at step 703, the mould cavity (containing the inclusions and food product) may be vibrated. The vibration of the mould cavity helps to create a smooth shell allows for greater control of the thickness of the shell. However, the intensity and duration of vibration that is used can be reduced as compared to a situation where the depositor plate of the present invention is not used to deposit the food product into the mould cavity.

Optionally at step 704, a stamp is inserted into the mould cavity to help shape the food product into a smooth shape. Furthermore, the stamp may be the stamp 600 shown in FIGS. 6A and 6B and inserted according to the process depicted therein.

Optionally at step 705, the stamp is then removed from the mould cavity, leaving a shell for a confectionery product.

The skilled person would appreciate that any number of additional steps used in forming confectionery products and understood by the skilled reader may also be included in the production of the shell.

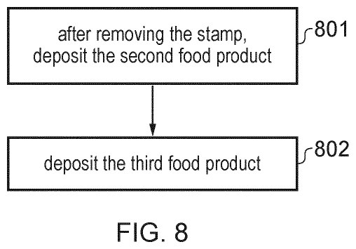

FIG. 8 is a flow chart for producing a confectionery product from a shell produced according to the method shown in FIG. 7. At step 801, after the stamp has been removed from the mould cavity, a second food product is deposited into the mould cavity. The second food product can be deposited into the shell using known means.

At step 802, a third food product is deposited onto the mould cavity through a second depositor plate comprising a plurality of nozzles to seal the second food product within the first and third food products. The third food product may be the same as the first food product.

The second depositor plate may be a depositor plate as shown in FIGS. 3A, 3B, 4A and 4B. Alternatively, the second depositor plate could be a different depositor plate comprising a plurality of nozzles configured to direct the third food product onto the mould cavity. The plurality of nozzles helps to prevent the third food product from mixing with the second food product.

The cross-sectional area over which the third food product is deposited through the second depositor plate is preferably smaller than a cross-sectional area of the mould cavity at the rim of the mould cavity. This helps to seal the confectionery product, while preventing spillage of the third food product outside of the mould cavity, causing wastage of (potentially expensive) ingredients. As an example, the confectionery product may have a circular cross-sectional shape, with a diameter of 31 mm, while the second depositor plate only deposits the third food product over 22.34 mm. Furthermore, if the shell includes an angled surface proximate the rim, as shown in FIG. 6C, it is not necessary to deposit the food product across the entire width of the shell in order to effectively seal the second food product within the first and third food products.

As described herein the method and apparatus described may also be used to make other consumable products such as savoury foods where it is desirable to provide visible inclusions around the surface of the product in an efficient and economical way.

The invention is further described with reference to the following examples. It will be appreciated that the invention as claimed is not intended to be limited in any way by these examples. It will be further recognised that the skilled reader will understand from the teaching herein that integers and features of different embodiments may be used in any suitable and advantageous combination.

### EXAMPLES

The following products were made using the method and apparatus of the present invention. The values given in the table relates to the percentage (%) amounts by weight of each component.

| | | | | | % visibility - | |
|---|---|---|---|---|---|---|
| Example | Filling | Shell | Back | Inclusion | surface area | Product description |
| 1 | 41.30 | 38.76 | 13.95 | 6 | 61 | Dark chocolate shell and |
| | | | | | | back, caramel filling and |
| | | | | | | 2-4 mm almond pieces, |
| | | | | | | 13.0 g |
| 2 | 33.91 | 40.24 | 20.79 | 5.06 | 67 | Milk chocolate shell and |
| | | | | | | back, dark chocolate |
| | | | | | | emulsion filling and |
| | | | | | | Cocoa Nibs 2-5 mm, |
| | | | | | | 12.55 g |
| 3 | 31.89 | 40.64 | 23.15 | 4.32 | 49 | Milk chocolate shell and |
| | | | | | | back, hazelnut paste and |
| | | | | | | hazelnut pieces, 12.63 g |
| 4 | 40.78 | 40.87 | 17.06 | 1.29 | 48 | Dark chocolate shell and |
| | | | | | | back, oil in water |
| | | | | | | raspberry emulsion and |
| | | | | | | freeze dried raspberry |
| | | | | | | pieces 0-6 mm, 11.86 g |

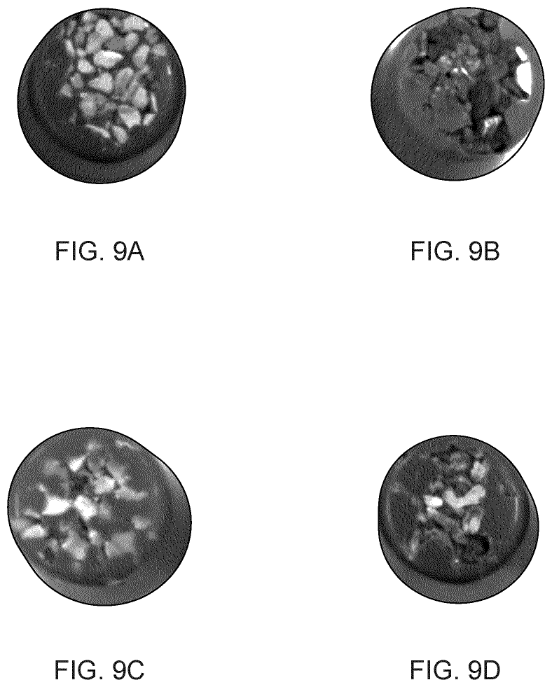

Examples 1-4 are shown in FIGS. 9A-9D respectively.

The inclusions were deposited in the moulds using an inclusion depositor as shown in the figures. The deposition conical orifices in the sliding plate have 11 m holes in the upper surface and 14 mm holes in the lower surface and deposit between 0.16 g (Example 4) and 1.16 g (Example 4).

The ingredients are dosed over 300 ms using an arm that travels forwards and backwards to push the ingredients into the holes of the depositor. The number of times that the arm goes forward and backwards per depositing cycle is 3 for Examples 1 and 3, 2 for Example 2 and 1 for Example 4. The sliding plate then deposits the inclusions.

Subsequently liquid chocolate at 29° C. is deposited using the depositor plate displayed in FIGS. 3A, 3B, 4A, and 4B. The depositor section 301 has a diameter of 22.34 mm and the mould cavity a diameter of 31 mm.

The second outer nozzle arrangement covers 7.5% of the surface area of the mould cavity opening and 13.6% of the surface area of the portion of the depositor plate for that mould cavity. The first inner nozzle arrangement covers 3.7% of the surface area of the mould cavity opening and 6.8% of the surface area of the portion of the depositor plate for that mould cavity, The centres of the second and first nozzle groups are separated by 50% of the radius of the depositing section.

The shells are cold-stamped using a stamp at a temperature of −16 to −17° C. for a time of 1200 ms or 1400 ms (Example 3). The stamp is fully inserted into the mould leaving a shell thickness of 4 mm on the profile surface and a wall thickness of 2 mm.

The filling is then deposited and the product is cooled. The products are subsequently backed off and licking rollers are used to remove excess chocolate and cooled at 14° C. The backing off is achieved using a plate as shown in in FIG. 10A and FIG. 10B, which show the same depositor plate from different angles. The components of the depositor plate in FIGS. 10A and 10B generally correspond to those of the depositor plate shown in FIGS. 3A and 3B, however the depositor plate of FIGS. 10A and 10B deposits chocolate over a smaller surface area and contains three depositing sections per recess. This ensures that the amount of chocolate wasted is minimised, i.e. chocolate is deposited on the product not on the mould.

The percentage visibility of the inclusions was assessed using an image of the product by measuring the pixel area and mapping a gate around the inclusions.

Examples 1 to 3 were repeated (Comparative Examples 1 to 3) using a ‘single-shot’ depositor.

The following differences were observed:

| Feature | | Comparative Examples 1 to 3 | Examples 1 to 4 |
|---|---|---|---|
| Visible | visibility | The ingredients are gathered | Consistent ingredients |
| Inclusions | | at one side of the product | visibility thanks to |
| | | due to mould movement | chocolate-shell |
| | | during production | depositing, and cold |
| | | | stamp shell forming. |
| | adherence/ | Only the larger Inclusions | Smaller inclusions |
| | size | adhered to the shell | (3-4 mm) can be |
| | | (6 mm approx.). | deposited and still |
| | | A portion of the inclusions | stick well to the shell. |
| | | is loose and get lost | |
| | | during demoulding. | |
| Shell | thickness | Thicker shell needed to | Thinner shell can |
| | | prevent leakages. | be achieved. |
| | uniformity | Heterogeneous shell | Uniform shell |
| | integrity/ | Higher Risk of leakages due | Better shell integrity |
| | leakages | to ingredients “piercing” the | (less leakages due to |
| | | shell and allowing the | ingredients “piercing” |
| | | filling to go through. | the shell and allowing |
| | | | the filling to go through) |
| | | | owing to cool stamp |
| | | | design. |
| Filling | repartition | The filling repartition | More consistent |
| | | depends strongly on the | repartition of the |
| | | filling viscosity. | filling/shell. |
| Backing | Flatness | Uneven backing off (outside | Flat and even backing off |
| off | (outside | visible part) and hard to remove | (inside part in contact with |
| | visible | bubbles/tail as shaking cannot | the filling, and outside |
| | part) | be used | visible part) thanks to cool |
| | | | core and rain plate. |
| | Flatness | Sinking backing off. | |
| | (inside part- | | |
| | cut view) | | |
| | integrity/ | Risks of leakages when the | Very small leakage risk |
| | leakages | filling is tailing. | with liquid filling. |

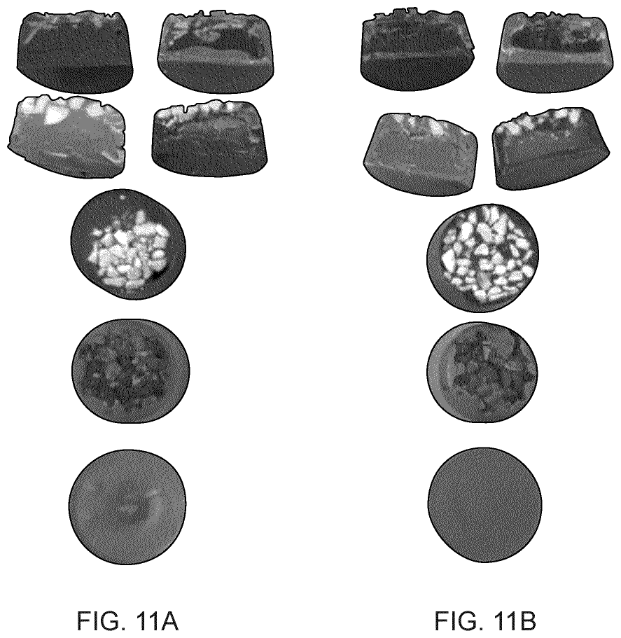

A side-by-side comparison of select examples above are shown pictorially in FIG. 11A (Comparative Examples 1-3: ‘single-shot’ deposition) and FIG. 11B (Inventive Examples 1-4).

### Comparative Example 4

Two prior art processes were assessed for their applicability in preparing the product of the present invention.

The process of WO2015166451 is unable to obtain the products of the present invention as the chocolate and inclusions are pre-mixed and the deposition does not allow the necessary control of the chocolate flow to afford visible conclusions. There is no information as to how to deposit the chocolate.

The process of WO2013006599 does not provide the control of the present invention in providing visible inclusions that are suitably bound to the shell. As shown in the figures and as would be provided by the vibration steps in the examples, the inclusions will be mixed into the chocolate prior to cold stamping, minimising the degree of visibility. There is no information as to how to deposit the chocolate.

Additionally, the deposition of inclusions and backing off methods of the present invention afford a greater control of both of these process steps than the methods of these documents.

1. A method of producing a confectionery product containing externally visible inclusions, the method comprising:
depositing one or more inclusions into a mould cavity; and
depositing a food product into the mould cavity through a depositor plate, the depositor plate comprising a plurality of nozzles configured to direct at least a portion of the food product towards a wall of the mould cavity.

2. The method of claim 1, wherein the plurality of nozzles comprises:
a first nozzle group configured to direct a first volume of the food product towards a central portion of the mould cavity; and
a second nozzle group configured to direct a second volume of the food product towards the wall of the mould cavity.

3. The methods of claim 2, wherein nozzles of the second nozzle group are arranged in a circumferential arrangement with respect to the first nozzle group.

4. The method of claim 2, wherein nozzles in the second nozzle group are angled with respect to the axis of nozzles in the first nozzle group.

5. The method of claim 1, wherein the depositor plate comprises additional nozzle groups for depositing the food product into additional mould cavities.

6. The method of claim 1, comprising: the additional step of inserting a stamp into the mould cavity to press the food product towards the wall of the mould cavity to form a shell for a confectionery material;
wherein a first portion of the stamp has a shape generally complementary to a shape of the mould cavity and penetrates the mould cavity such that a distance between a central region of an outer surface of the first portion of the stamp and an inner surface of the mould cavity is greater than a diameter of the one or more inclusions; and
wherein a second portion of the stamp does not penetrate the mould cavity.

7. The method of claim 6, wherein the second portion of the stamp additionally comprises a chamfer located proximate the first portion.

8. The method of claim 6, wherein the second portion of the stamp abuts a rim of the mould cavity.

9. The method of claim 1, wherein depositing one or more inclusions into a mould cavity comprises depositing one or more inclusions into a mould cavity through an inclusion depositor, wherein the inclusion depositor comprises:
an upper plate comprising one or more holes;
a lower plate comprising one or more, the intermediate plate positioned proximate to the mould cavity during deposition of the one or more inclusions;
an intermediate plate comprising one or more holes, the intermediate plate positioned between the upper plate and the lower plate;
the intermediate plate is slideable between a first position, in which the one or more holes of the intermediate plate are aligned with the one or more holes of the upper plate, and a second position, in which the one or more holes of the intermediate plate are aligned with the one or more holes of the lower plate; and
during deposition of the one or more inclusions into the mould cavity, the one or more inclusions sequentially pass through the upper plate, the intermediate plate and the lower plate.

10. The method of claim 9, wherein the one or more holes of the lower plate of the inclusion depositor have a diameter that is greater than a diameter of the one or more holes of the upper plate of the inclusion depositor, and
wherein the one or more holes of the intermediate plate have a conical shape, and the one or more holes of the intermediate plate having a smallest diameter equal to the diameter of the one or more holes of the upper plate, and the one or more holes of the intermediate plate having a largest diameter equal to the one or more holes of the lower plate.

11. The method of claim 9, wherein the one or more holes of the upper plate are laterally offset from the one or more holes of the lower plate.

12. The method of claim 1, further comprising the additional step of vibrating the mould cavity after depositing the food product into the mould cavity.

13. (canceled)

14. An inclusion depositor for depositing inclusions into mould cavities, the inclusion depositor comprising:
an upper plate comprising one or more holes;
a lower plate comprising one or more, the intermediate plate positioned proximate to the mould cavity during deposition of the one or more inclusions;
an intermediate plate comprising one or more holes, the intermediate plate positioned between the upper plate and the lower plate; and
wherein the intermediate plate is slideable between a first position, in which the one or more holes of the intermediate plate are aligned with the one or more holes of the upper plate, and a second position, in which the one or more holes of the intermediate plate are aligned with the one or more holes of the lower plate.

15. A depositor plate for use in producing shells for confectionery products containing externally visible inclusions, the depositor plate comprising:
a plurality of nozzles configured to direct at least a portion of a food product towards a wall of a mould cavity.

16-19. (canceled)
